(19) United States
(12) Patent Application Publication
(10) Pub. No.: US 2011/0263145 A1
(43) Pub. Date: Oct. 27, 2011

(54) MULTI-CIRCUIT RECEPTACLE SHUTTER ASSEMBLY

(76) Inventor: Kyung T. Kim, Laguna Niguel, CA (US)

(21) Appl. No.: 12/990,004

(22) PCT Filed: Jun. 4, 2009
(86) PCT No.: PCT/US2009/046300

§ 371 Date: Oct. 28, 2010

Related U.S. Application Data
(60) Provisional application No. 61/059,076, filed on Jun. 5, 2008.

(51) Int. Cl. H01R 13/44

(52) U.S. Cl. 439/137

(57) ABSTRACT

A shutter assembly for an electrical receptacle comprises a plurality of apertures, each configured to be in communication with a different one of at least three terminals of the electrical receptacle. The shutter assembly is configured to block access to each of the terminals upon insertion of a foreign object into only one of the apertures. The shutter assembly is also configured to allow access to two of the terminals upon simultaneous insertion of two prongs of a plug into two of the apertures.

### CLAIM FOR PRIORITY

This application claims priority to U.S. Provisional Patent Application No. 61/059,076, filed Jun. 5, 2008, the entire disclosure of which is hereby incorporated by reference herein.

### BACKGROUND

1. Field

The present application relates generally to electrical receptacles, and, more particularly, to safety mechanisms for receptacles including a plurality of circuits.

2. Description of the Related Art

Electrical receptacles are utilized in large numbers to provide ready access for electricity to power a variety of electrical devices. The electrical receptacle generally has apertures through which a live or hot electrical terminal, a neutral electrical terminal, and a ground terminal may be accessed by insertion of an elongate object. Electrical devices are generally connected to an electrical receptacle by an electric power cord with a plug at one end and connected to the device at the other end. The plug generally has a live or hot prong and a neutral prong, and may have a ground prong. The prongs of the plug are aligned with apertures (e.g., slots) of the electrical receptacle. The hot prong and neutral prong may be different sizes such that the neutral prong can only fit into the neutral electrical terminal. This polarity may increase safety and may improve the performance of certain devices. The ground prong may be longer than the hot and neutral prongs so the electrical device is grounded before receiving power.

### BRIEF DESCRIPTION OF THE DRAWINGS

These and other features, aspects, and advantages of the invention disclosed herein are described below with reference to the drawings of certain embodiments, which are intended to illustrate and not to limit the invention.

FIG. 1 is a top/front perspective view of an example embodiment of a multi-circuit receptacle and plug.

FIG. 2 is an exploded top/front perspective view of an example embodiment of a shutter assembly.

FIG. 3 is a front/bottom/side perspective view of an example embodiment of a hot slot shutter.

FIG. 4 is a front/bottom/side perspective view of another example embodiment of a hot slot shutter.

FIG. 5 is a top/front/side perspective view of the hot slot shutters of FIGS. 3 and 4 interacting with each other.

FIG. 6 is a front elevational view of the hot slot shutters of FIGS. 3 and 4 interacting with each other.

FIG. 7 is a front/bottom/side perspective view of another example embodiment of a hot slot shutter.

FIG. 8 is a front/bottom/side perspective view of two hot slot shutters of FIG. 7 interacting with each other.

FIG. 9 is a front/bottom/side perspective view of an example embodiment of a neutral slot shutter.

FIG. 10 is a top/front perspective view of another example embodiment of a neutral slot shutter.

FIGS. 11A and 11B are top/front perspective views of the hot slot shutters of FIGS. 3 and 4 interacting with the neutral slot shutter of FIG. 9.

FIG. 12 is a front elevational view of the hot slot shutters of FIGS. 3 and 4 and the neutral slot shutter of FIG. 9 interacting with each other.

FIG. 13 is a bottom elevational view of the hot slot shutters of FIGS. 3 and 4 and the neutral slot shutter of FIG. 9 interacting with each other.

FIG. 14 is a bottom elevational cut-away view of an example embodiment of a shutter assembly comprising the hot slot shutters of FIGS. 3 and 4 and the neutral slot shutter of FIG. 9.

FIG. 15 is an example embodiment of a foreign object.

FIGS. 16A and 16B illustrate a foreign object being inserted into an aperture of the shutter assembly of FIG. 14.

FIGS. 17A and 17B illustrate a foreign object being inserted into another aperture of the shutter assembly of FIG. 14.

FIGS. 18A and 18B illustrate a two-prong plug being inserted into two apertures of the shutter assembly of FIG. 14.

FIGS. 19A and 19B illustrate a foreign object being inserted into an aperture of the shutter assembly of FIG. 14.

FIG. 20 is a back/top/side perspective view of an example embodiment of a face plate.

FIG. 21 is a back/top/side perspective view of the face plate of FIG. 20 and the hot slot shutters of FIGS. 3 and 4 interacting with each other.

FIG. 21A is an expanded view of the area defined by the circle A in FIG. 21.

FIG. 22A illustrates a foreign object being inserted into an aperture of another example embodiment of a shutter assembly.

FIG. 22B is an expanded view of the area defined by the circle B in FIG. 22A.

FIGS. 23A and 23B illustrate a foreign object being inserted into an aperture of yet another example embodiment of a shutter assembly.

FIG. 24 illustrates a foreign object being inserted into an aperture of the shutter assembly of FIG. 22A.

### SUMMARY

In one embodiment, a shutter assembly for an electrical receptacle comprises a plurality of apertures, each configured to be in communication with a different one of at least three terminals of the electrical receptacle. The shutter assembly is configured to block access to each of the terminals upon insertion of a foreign object into only one of the apertures. The shutter assembly is also configured to allow access to two of the terminals upon simultaneous insertion of two prongs of a plug into two of the apertures.

In another embodiment, an electrical receptacle comprises at least three terminals and a shutter assembly. The shutter assembly comprises a plurality of apertures configured to be in communication with a different one of the at least three terminals. The shutter assembly is configured to block access to each of the three terminals upon insertion of a foreign object into only one of the apertures. The shutter assembly is also configured to allow access to two of the terminals upon simultaneous insertion of two prongs of a plug into two of the apertures.

In another embodiment, a shutter assembly for an electrical circuit comprises at least three terminals configured to receive a plug having two prongs. The shutter assembly comprises first, second, and third blocking members, as well as first, second, and third bias members. The first blocking member comprises a first inclined surface, a first open portion, and a first blocking portion configured to cover at least a first terminal of the terminals in a relaxed position. The first bias member is configured to bias the first blocking member towards its relaxed position when the first blocking member is moved to an actuated position of the first blocking member. The second blocking member comprises a second inclined surface, a second open portion, and a second blocking portion configured to cover at least a second terminal of said terminals in a relaxed position. The second bias member is configured to bias the second blocking member toward its relaxed position when the second blocking member is moved to an actuated position of the second blocking member. The third blocking member comprises a third inclined surface, a third open portion, and a third blocking portion configured to cover at least a third terminal of said terminals in a relaxed position. The third bias member is configured to bias the third blocking member towards its relaxed position when the third blocking member is moved to an actuated position of the third blocking member.

For purposes of summarizing the invention and the advantages achieved over the prior art, certain objects and advantages of the invention have been described above and as further described below. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### DETAILED DESCRIPTION

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention herein disclosed should not be limited by the particular disclosed embodiments described below.

Unprotected, the apertures of an electrical receptacle may admit foreign objects in addition to prongs. For example, a foreign object may include a screwdriver, a knife, a paper clip, a utensil, and a metal tang or protrusion of a child's toy. These electrically-conducting foreign objects can thus present an electrical shock hazard to someone who deliberately or inadvertently inserts such a foreign object into an aperture of the electrical receptacle.

U.S. Pat. No. 4,379,607 to Bowden, Jr., which is incorporated herein by reference in its entirety, describes a shutter assembly for a traditional electrical receptacle consisting of two electrical terminals. A foreign object directed towards the hot electrical terminal or the neutral electrical terminal is prevented from contacting the electrical terminal, but allows access to the hot and neutral electrical terminals when two prongs of a plug are simultaneously (i.e., occurring at least partially at the same time) directed towards both the hot and neutral electrical terminals. In some jurisdictions, such shutter assemblies or other safety devices are required by electrical codes. However, the embodiments described in Bowden, Jr. cannot be directly translated to a multi-circuit receptacle having more than two electrical terminals. For example, if two shutters as described in Bowden, Jr. were mechanically linked, one terminal would be exposed upon the insertion of a plug into two other terminals. For another example, if two shutters as described in Bowden, Jr. were stacked, the thickness of the shutter assembly would consume the length of the plug prongs, thereby causing poor connection to the electrical terminals.

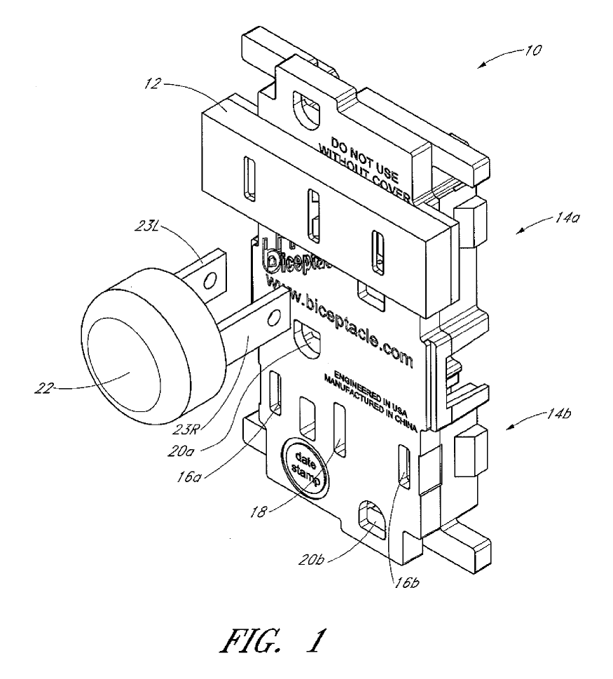

FIG. 1 illustrates an example embodiment 10 of an electrical receptacle comprising at least three terminals and a shutter assembly 12. Each of the upper and lower multi-circuit receptacles 14a and 14b comprises two circuits. For example, in the multi-circuit receptacle 14b, a first circuit comprises a first hot electrical terminal 16a and a neutral electrical terminal 18, and a second circuit comprises a second hot electrical terminal 16b and the neutral electrical terminal 18. Each electrical circuit may further comprise a ground terminal. In the illustrated multi-circuit receptacle 14b, one ground terminal 20a is disposed above the first circuit terminals 16a and 18, and another ground terminal 20b is disposed below the second circuit terminals 18 and 16b. A plug or foreign body 22 with left prong 23L and right prong 23R can be inserted into a pair of terminals, e.g., 16a and 18 or 16b and 18. Such electrical receptacles are described in detail in co-owned U.S. Pat. Nos. 7,052,299, 7,071,414, 7,198,499, and 7,214,079, U.S. Design Pat. No. D532,375, U.S. Patent Application Publication No. 2007/0184703, and PCT Patent Application Publication No. WO 2007/095249, each of which is incorporated herein by reference in its entirety. Electrical receptacles having only one multi-circuit receptacle or more than two multi-circuit receptacles are also possible. In some embodiments, a building comprises a plurality of the electrical receptacles of the invention, such as example embodiment 10 illustrated in FIG. 1.

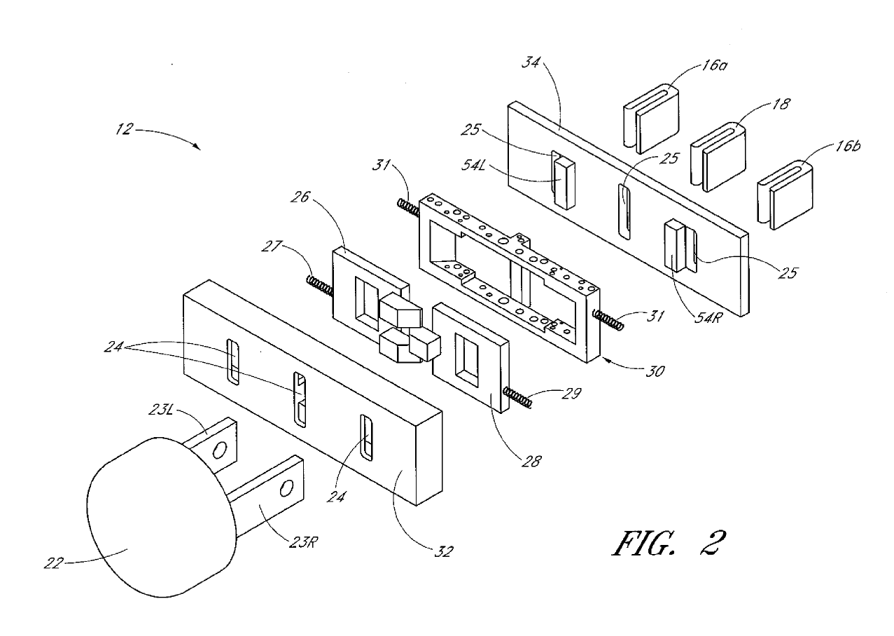

FIG. 2 illustrates an exploded view of an example embodiment of a shutter assembly 12 compatible with either of the multi-circuit receptacles 14a, 14b of FIG. 1. The shutter assembly 12 comprises apertures 24 configured to be in communication with each of at least three terminals 16a, 18, and 16b of the electrical receptacle. The shutter assembly 12 is configured to block (i.e., to prevent an electrical connection with) each of the terminals upon insertion of a foreign object into one of the apertures 24. The shutter assembly 12 is also configured to allow electrical access to two of the terminals (i.e., 16a and 18, or 16b and 18) upon insertion of a plug 22 comprising two prongs 23L and 23R.

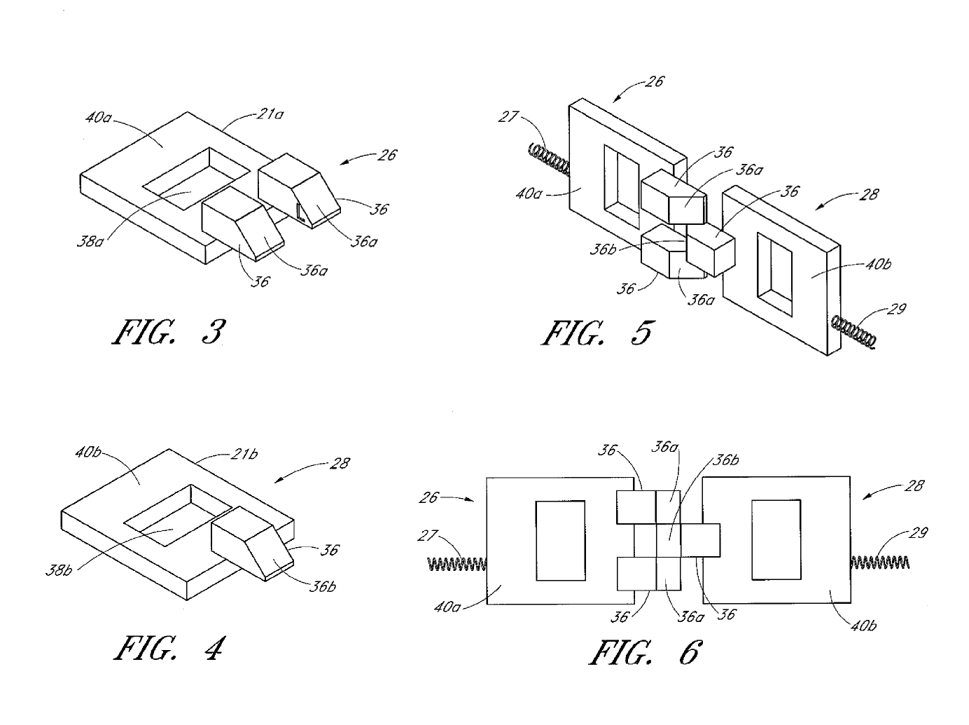

In some embodiments, and as shown in FIG. 2, the shutter assembly 12 comprises a first blocking member 26 (also referred to herein as the left hot slot shutter), a first bias member 27, a second blocking member 28 (also referred to herein as the right hot slot shutter), a second bias member 29, a third blocking member 30 (also referred to herein as the neutral slot shutter), and a third bias member 31. As shown in FIG. 3, the first blocking member 26 comprises an inclined surface 36a, an open portion 38a, and a blocking portion 40a configured to cover at least a first terminal 16a of the multi-circuit receptacle in a relaxed state. As shown in FIG. 4, the second blocking member 28 comprises an inclined surface 36b, an open portion 38b, and a blocking portion 40h configured to cover at least a second terminal 16b of the multi-circuit receptacle in a relaxed state. As shown in FIG. 9, the third blocking member 30 comprises an inclined surface (in this embodiment, a pair of inclined surfaces 46a, 46b), an open portion 48, and a blocking portion 50 configured to cover at least a third terminal 18 of the multi-circuit receptacle in a relaxed state. Referring again to FIG. 2, the first, second, and third blocking members 26, 28, and 30, respectively, are interleaved rather than being interlocked such that they may act independently or in unison, as desired. The first bias member 27 is configured to inwardly bias the first blocking member 26 upon outward actuation of the first blocking member. The second bias member 29 is configured to inwardly bias the second blocking member 28 upon outward actuation of the second blocking member. The third bias member 31 is configured to inwardly bias the third blocking member 30 upon outward actuation of the third blocking member. In some embodiments, such as in FIG. 2, the shutter assembly 12 comprises a bias member 31 on each side of the third blocking member 30. In some embodiments, each of the first, second, and third blocking members may each or all comprise a plurality of bias members. Although illustrated as coil springs, the first, second, and third bias members 27, 29, and 31, respectively, may also comprise leaf springs or other suitable means for applying an inward bias to the blocking members.

In some embodiments, the shutter assembly further comprises a face plate 32 and a back plate 34. The face plate 32 comprises a portion disposed on a first side of the first, second, and third blocking members 26, 28, and 30, respectively, and which faces outwardly from the electrical receptacle 14a, as illustrated in FIG. 1. In some embodiments, the face plate 32 comprises a plurality of sidewalls 35 configured to substantially enclose the first, second, and third blocking members, 26, 28, and 30, and the first, second, and third bias members, 27, 29, and 31. The back plate 34 is disposed on a second opposite side of the first, second, and third blocking members, and is disposed between the first, second, and third blocking members and the electrical terminals 16a, 18, and 16b, as illustrated in FIG. 2. In certain embodiments, each of the face plate 32 and the back plate 34 comprises apertures 24, 25 (e.g., slots) corresponding to each terminal 16a, 18, 16b of the multi-circuit receptacle (e.g., having approximately the same size and shape as a cross-section of each terminal, and aligned with each terminal).

FIG. 3 illustrates an example embodiment of a blocking member or left hot slot shutter 26. The blocking member 26 comprises an inclined surface 36a (also referred to herein as a shutter actuation ramp), an open portion 38a (also referred to herein as a hot plug prong slot), and a blocking portion 40a (also referred to herein as a hot slot blocking area) configured to cover at least one terminal of a multi-circuit receptacle in a relaxed state. In the illustrated embodiment, the inclined surface 36a comprises a pair of shutter actuation ramps. In some embodiments, the blocking member 26 comprises a generally planar body 21a comprising the blocking area 40a and an open area (e.g., aperture) 38a through the generally planar body, and one or more fingers 36 comprising the inclined surface 36a. In certain such embodiments, the one or more fingers 36 protrude above the generally planar body 21a. In the embodiment illustrated in FIG. 3, the blocking member 26 comprises two fingers 36 spaced from each other, and the inclined surfaces 36a of the fingers are substantially aligned. In some embodiments, the open portion 38a is disposed between the blocking portion 40a and the inclined surface 36a.

FIG. 4 illustrates another example embodiment of a blocking member 28, or right hot slot shutter. The blocking member 28 comprises an inclined surface 36b (or shutter actuation ramp), an open portion 38b (or hot plug prong slot), and a blocking portion 40b (or hot slot blocking area), configured to cover at least one terminal of a multi-circuit receptacle in a relaxed state. In some embodiments, the blocking member 28 comprises a generally planar body 21b comprising the blocking area 40b and an open area (e.g., aperture) 38b through the generally planar body, and one or more fingers 36 comprising the inclined surface 36b. In certain such embodiments, the one or more fingers 36 protrude above the generally planar body 21b. In the embodiment illustrated in FIG. 4, the blocking member 28 comprises one finger 36. In some embodiments, the open portion 38b is disposed between the blocking portion 40b and the inclined surface 36b.

FIG. 5 illustrates the blocking members 26 and 28 of FIGS. 3 and 4 interacting with each other (e.g., being interleaved). The inclined surfaces 36a of the blocking member 26 are facing an opposite direction than the inclined surface 36b of the blocking member 28. If a foreign object or plug is directed towards the inclined surfaces 36a, 36b, the blocking member 26 is actuated to the left due to the inclined surface 36a translating the force, and the blocking member 28 is actuated to the right due to the inclined surface 36b translating the force. If the foreign object or plug is removed, the bias members 27 and 29 cause the blocking members 26 and 28 to return to the relaxed state. In the illustrated embodiment, the blocking portion 40a of the blocking member 26 and the blocking portion 40b of the blocking member 28 are disposed substantially on a first plane, and the fingers 36 of the blocking member 26 and the finger 36 of the blocking member 28 are disposed substantially on a second plane.

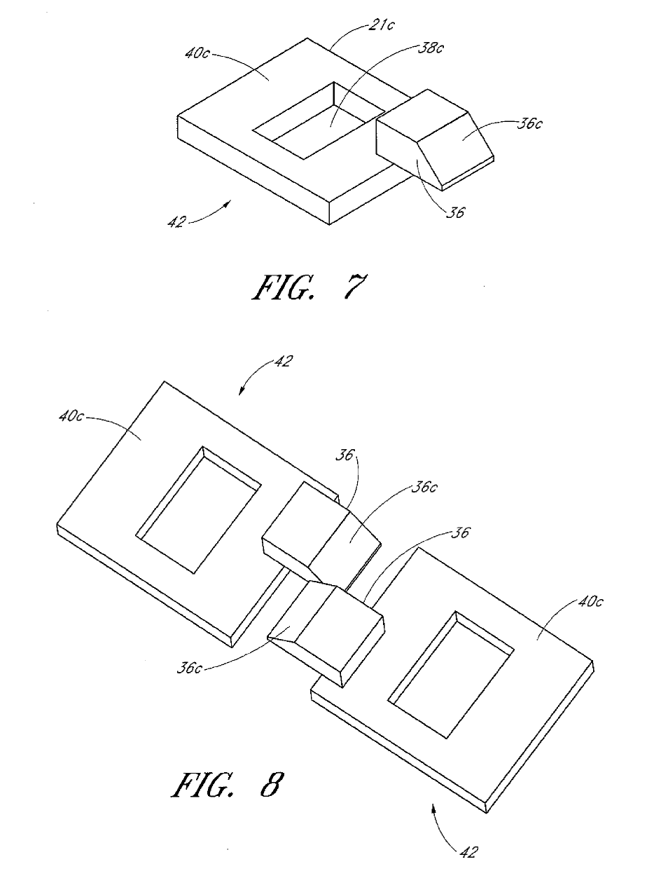

FIG. 6 illustrates a front plan view of the blocking members 26 and 28 interacting with each other (e.g., being interleaved). The finger 36 of the blocking member 28 is disposed between the fingers 36 of the blocking member 26. In some embodiments, one or both of the fingers 36 of the blocking member 26 are adjacent to the finger 36 of the blocking member 28. The ramps 36a, 36b of the fingers 36 of the blocking members 26 and 28 are generally aligned (e.g., substantially aligned), such that a foreign object or plug exerting a force into the inclined surfaces 36a, 36b will cause lateral displacement (e.g., outward displacement) of each of the blocking members. In embodiments in which at least one of the blocking members 26, 28 comprises more than one finger 36 and in which the fingers 36 of one blocking member are interleaved with the finger 36 of the other blocking member, rotation upon application of a downward force may be reduced because the interleaving of the fingers 36 may transversely restrain the blocking members.

FIG. 7 illustrates yet another example embodiment of a blocking member or slot shutter 42. The blocking member 42 comprises an inclined surface (or shutter actuation ramp) 36c, an open portion (or hot plug prong slot) 38c, and a blocking portion (or hot slot blocking area) 40c configured to cover at least a first terminal of a multi-circuit receptacle in a relaxed state. In some embodiments, the blocking member 42 comprises a generally planar body 21c comprising the blocking area 40c and an open area (e.g., aperture) 38c through the generally planar body, and a finger 36 comprising the inclined surface 36c. In the embodiment illustrated in FIG. 7, the blocking member 42 comprises one finger 36. In certain such embodiments, the finger 36 protrudes above the generally planar body 21c. In the embodiment illustrated in FIG. 7, the finger 36 is disposed to one side of the blocking member 42 to form a half ramp. In certain such embodiments, the blocking member 42 may interact with a substantially similar (e.g., an identical) blocking member.

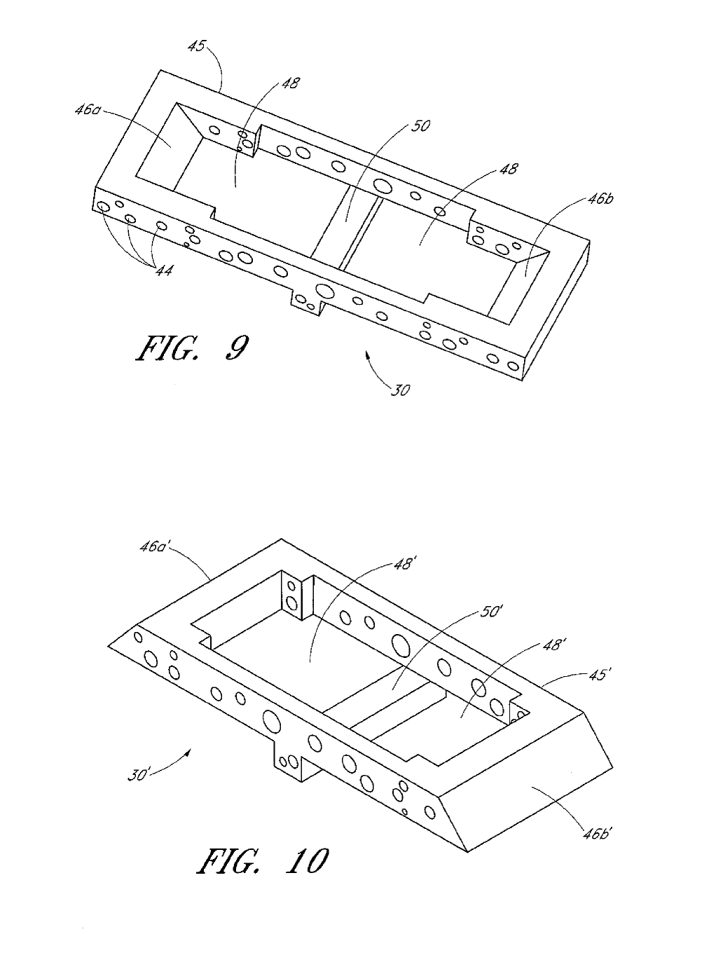

FIG. 8 illustrates two of the blocking members 42 of FIG. 7 interacting with each other (e.g., being interleaved). The inclined surfaces 36c of the blocking members 42 face opposite directions. In some embodiments, the finger 36 of one blocking member 42 is adjacent to the finger 36 of the other blocking member 42. In some embodiments, these fingers 36 will be positioned directly underneath the center slot 24 on the Tamper-Resistant Shutter Assembly (TRSA) face 32 of FIG. 2. The ramps 36c of the fingers 36 of the blocking members 42 are generally aligned (e.g., substantially aligned), such that a foreign object or plug exerting a force into the inclined surfaces 36c will cause lateral displacement (e.g., outward displacement) of each of the blocking members. If a foreign object or plug is directed towards the inclined surfaces 36c, the blocking members 42 are actuated in opposite directions due to the inclined surfaces translating the force. If the foreign object or plug is removed, bias members may cause the blocking members 42 to return to the relaxed state. In the illustrated embodiment, the blocking portions 40c of the blocking members 42 are disposed substantially on a first plane, and the fingers 36 of the blocking members are disposed substantially on a second plane. In certain embodiments, a blocking member 42 having one finger 36 may be easier to manufacture than a blocking member comprising more than one finger. In some embodiments, substantially identical blocking members may reduce manufacturing cost and complexity because only one type of blocking member would need to be fabricated.

FIG. 9 illustrates an example embodiment of the blocking member 30 (e.g., the neutral slot shutter) of FIG. 2. The “Swiss cheese” holes 44 are for illustration purposes only, the purpose of which will be apparent below. The blocking member 30 comprises an inclined surface (illustrated as a pair of inclined surfaces 46a, 46b, also referred to herein as shutter actuation ramps), an open portion 48, and a blocking portion 50 (also referred to herein as the neutral slot blocker) configured to cover at least one terminal of a multi-circuit receptacle in a relaxed state. In some embodiments, the blocking portion 50 is disposed within the open area 48 to define a plurality of apertures. In some embodiments, the blocking member 30 comprises a plurality of inclined surfaces. In the embodiment illustrated in FIG. 9, the blocking member comprises two inclined surfaces 46a, 46b each facing each other such that a foreign object or plug exerting a force into one of the inclined surfaces will cause lateral displacement of the blocking member 30 in a first direction, and a foreign object or plug exerting a force into the other of the inclined surfaces will cause lateral displacement of the blocking member 30 in a second opposite direction. FIG. 10 illustrates yet another example embodiment of a blocking member or neutral slot shutter 30′ with an opening 48′ and a blocking portion 50′ and comprising two inclined surfaces 46a′, 46b′ facing away from each other such that a foreign object or plug exerting a force into one of the inclined surfaces will cause lateral displacement of the blocking member in a first direction, and a foreign object or plug exerting a force into the other of the inclined surfaces will cause lateral displacement of the blocking member in a second opposite direction. If a foreign object or plug is directed towards either of the inclined surfaces 46 of either FIG. 9 or FIG. 10, the blocking member 30, 30′ is actuated due to the inclined surface 46 translating the force. If the foreign object or plug is removed, bias members may cause the blocking member 30 or 30′ to return to the relaxed state. In some embodiments, the blocking member 30 or 30′ comprises a generally planar body 45 or 45′ comprising the inclined surfaces 46 and an open area (e.g., aperture) 48 or 48′ through the generally planar body between the inclined surfaces. In certain such embodiments, the blocking portion 50 or 50′ protrudes below the generally planar body 45, 45′.

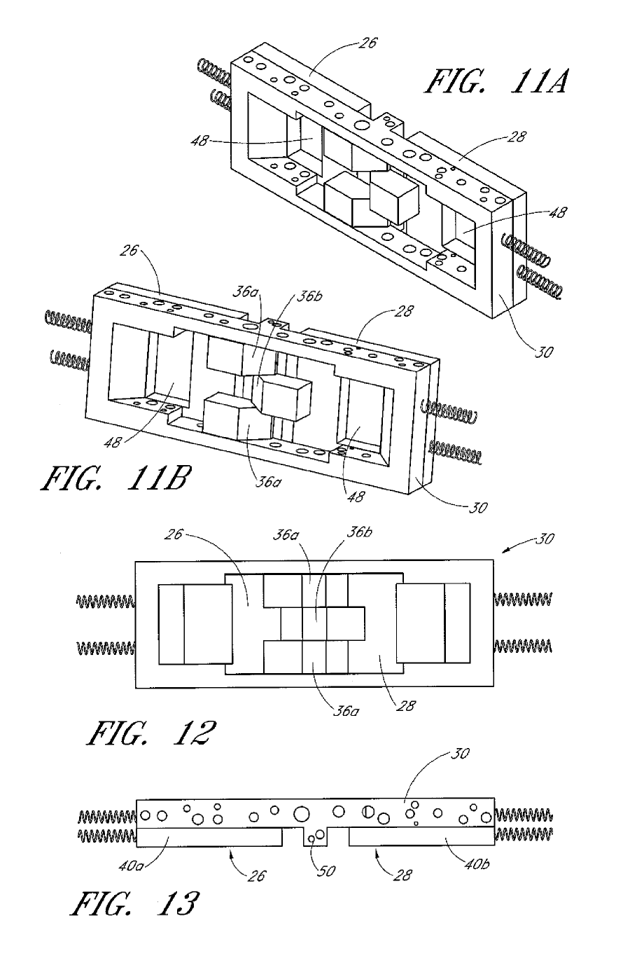

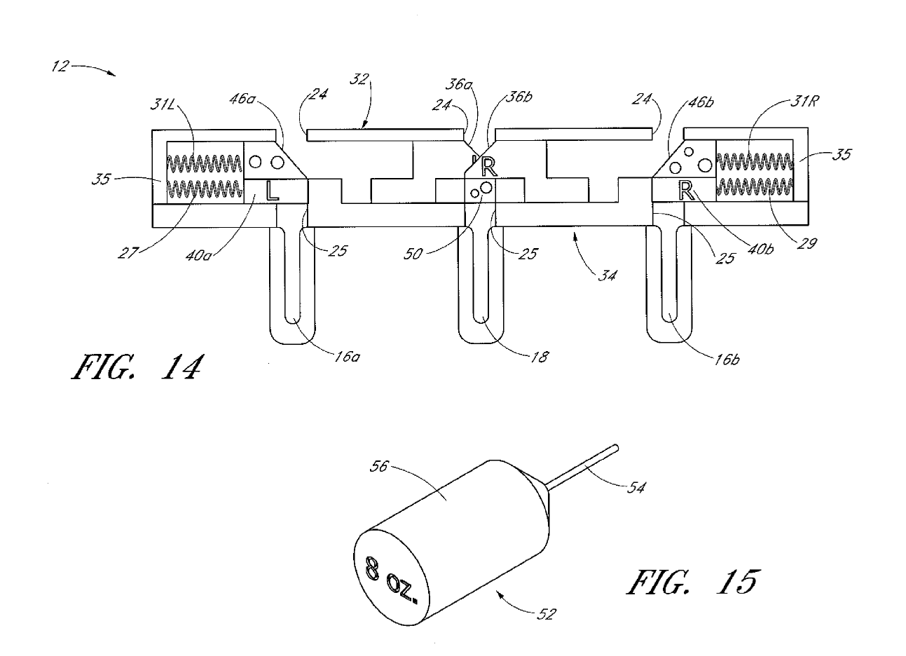

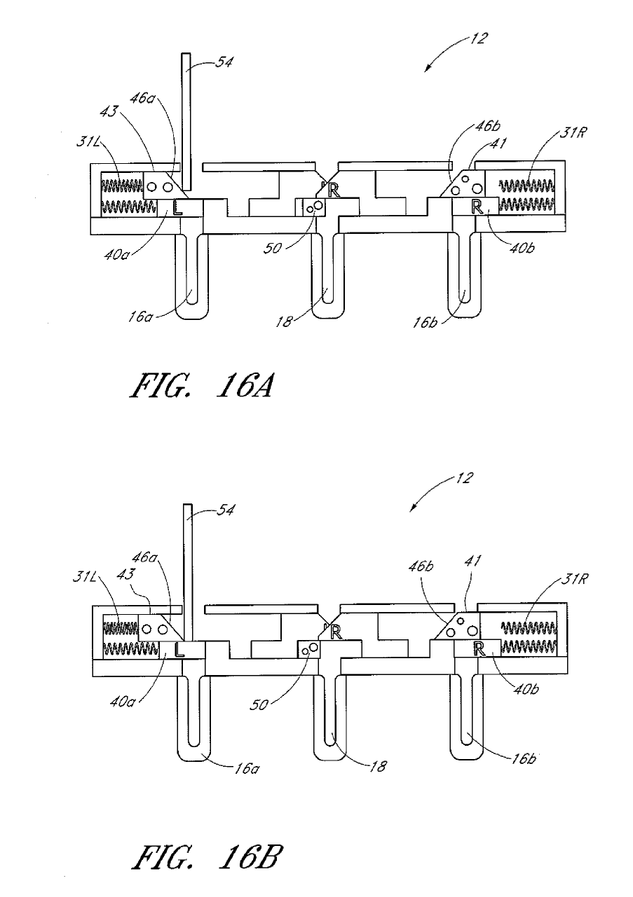

The assembly of the blocking members is now described. Reference is primarily made to FIGS. 11-13, but certain details are better understood from FIGS. 3, 4, and 9, described above. FIGS. 11A and 11B illustrate perspective views of the blocking members 26, 28, 30 of FIGS. 3, 4, and 9, respectively, interacting with each other (e.g., being interleaved). In some embodiments, the open area 48 of the blocking member 30 defines the area available for movement of at least one of the blocking members 26, 28 (e.g., by defining stop surfaces or shoulders). FIG. 12 is a front plan view of the blocking members 26, 28, and 30 interacting with each other. FIG. 13 is a bottom elevational view of the same blocking members 26, 28, and 30 interacting with each other. In the illustrated embodiment, the inclined surfaces 36a and 36b of the blocking members 26 and 28, respectively, are generally disposed within the open area 48 of the blocking member 30. In some embodiments, blocking portions 40a, 40b of the blocking members 26 and 28 and the blocking portion 50 of the blocking member 30 are disposed substantially on a first plane, and the fingers 36 of the blocking members 26, 28 are disposed substantially on a second generally parallel plane. In certain such embodiments, the thickness of the shutter assembly may be advantageously reduced such that prongs of a plug (e.g., prongs 23L and 23R of plug 22 of FIG. 1) may have good interaction with the electrical terminals (e.g., terminals 16a, 16b, and 18) behind the shutter assembly.

FIG. 14 illustrates a partial cut-away view of a shutter assembly 12 comprising the blocking members 26, 28, and 30 of FIGS. 3, 4, and 9 (unlabeled in FIG. 14), biasing members 27, 29, 31L, and 31R, a face plate 32 (also referred to herein as a “front plate”), and a back plate 34. The back plate 34 is disposed proximate to electrical terminals 16a, 18, and 16b of a multi-circuit receptacle. The apertures (e.g., slots) 24, 25 of the front plate 32 and the back plate 34 preferably correspond to each terminal 16a, 18, 16b of the multi-circuit receptacle (e.g., having approximately the same size and shape as a cross-section of each terminal, aligned with each terminal). The illustrated biasing members 27, 29, 31L, and 31R are disposed between their respective blocking members and the sidewalls 35 of the face plate 32. In some embodiments, the back plate 34 may comprise the sidewalls 35, instead of or in addition to the face plate 32. In embodiments in which the biasing members 27, 28, 31L and 31R comprise leaf springs, the biasing members may interact with the planar portion of the face plate 32 or the back plate 34. The biasing members 27, 29, 31L and 31R are configured to apply force to the blocking members 26, 28, and 30 when the blocking members are in an actuated position (e.g., when displaced by a plug or a foreign object).

With continued reference to FIG. 14, the inclined surfaces 46a and 46b of the blocking member 30 are disposed above (i.e., in front of) terminals 16a and 16b (e.g., the left hot electrical contact and the right hot electrical contact), respectively. The blocking portion 40a of the blocking member 26 (denoted as “L”) is disposed above one of these terminals 16a, and the blocking portion 40b of the blocking member 28 (denoted as “R”) is disposed above the other of these terminals 16b. The open portion 38a (FIG. 3) of the blocking member 26 is disposed to the right of the blocking portion 40a of the blocking member 26, such that when the blocking member 26 is in an actuated state (e.g., due to a foreign object or plug applying a force to the inclined surface 36a of the blocking member 26, the open portion 38a corresponds in position to the terminal 16a covered by the blocking portion 40a in the blocking member's relaxed state. The open portion 38b (FIG. 4) of the blocking member 28 is disposed to the left of the blocking portion 40b of the blocking member 28 such that when the blocking member 28 is in an actuated state (e.g., due to a foreign object or plug applying a force to the inclined surface 36b of the blocking member 28), the open portion 38b corresponds in position to the terminal 16b covered by the blocking portion 40b in the blocking member's relaxed state. The inclined surfaces 36a, 36b of the blocking members 26 and 28 are disposed above another terminal 18 (e.g., the neutral electrical contact). The blocking portion 50 of the blocking member 30 (denoted by “Swiss cheese” holes) is disposed above this terminal 18. The open portion 48 (FIG. 9) of the blocking member 30 is disposed to the left and to the right of the blocking portion 50 of the blocking member 30, such that when the blocking member 30 is in an actuated state (e.g., due to a foreign object or plug applying a force to either of the inclined surfaces 46a, 46b of the blocking member 30, the open portion 48 corresponds in position to the terminal 18 covered by the blocking portion 50 in the blocking member's relaxed state.

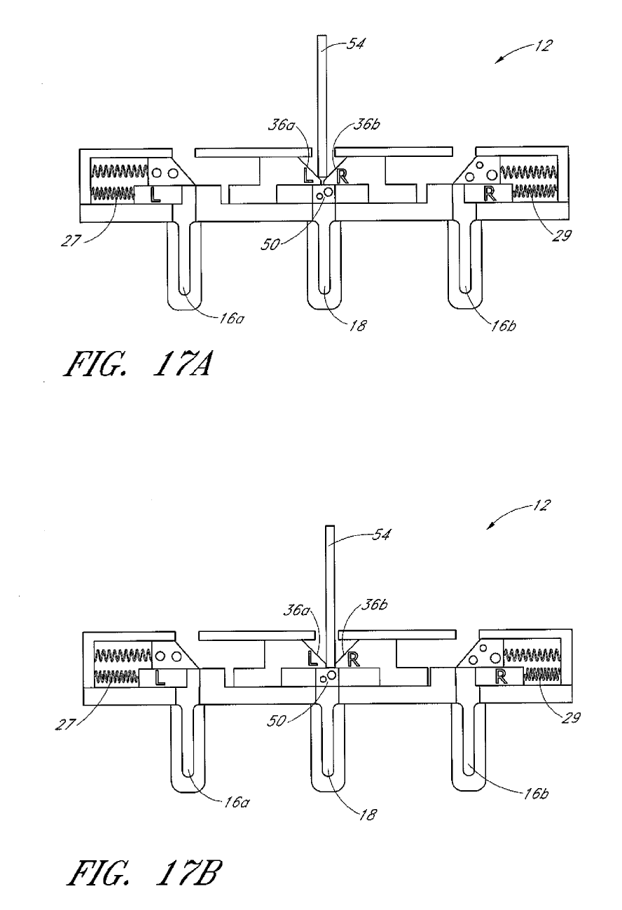

FIG. 15 illustrates an example embodiment of a foreign object 52 that may be used to test the shutter assembly 12 (e.g., a foreign object test pin). The foreign object 52 comprises a 1/32 inch diameter outwardly extending elongate member 54 mechanically coupled to an 8 ounce weight 56. A user may hold the 8 ounce weight 56 to manipulate the elongate member 54, for example at various angles and orientations. It will be understood that the dimensions, size, and weight of the object 52 may vary.

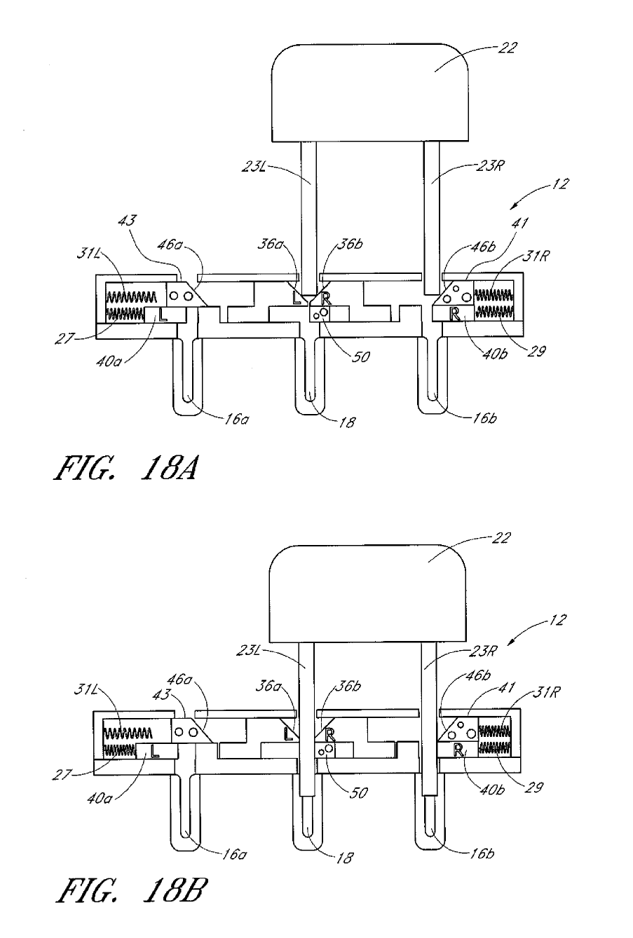

FIGS. 16A and 16B illustrate an example embodiment of an elongate member 54 of a foreign object being directed towards the left terminal 16a. The downward force of the elongate member 54 is distributed due to the angle of the inclined surface 46a of the blocking member 30 (FIG. 9), thereby causing the blocking member 30 to actuate to the left, compressing the left bias member 31L. The elongate member 54 is prevented from contacting the left terminal 16a by the blocking portion 40a of the blocking member 26, which is in a relaxed state because a foreign object is not also directed towards the middle terminal 18. The shutter assembly 12 thereby provides tamper resistance during unintended uses of the multi-circuit receptacle. In some embodiments, the blocking member 30 comprises a surface 41 that blocks the right terminal 16b in an actuated position.

Although not illustrated, it will be appreciated that an elongate member 54 of a foreign object being directed towards the right terminal 16b would have a similar but opposite effect on the blocking member 30. The downward force of the elongate member 54 is distributed due to the angle of the inclined surface 46b of the blocking member 30, thereby causing the blocking member 30 (the ramp of which is denoted by the “Swiss cheese” holes) to actuate to the right, compressing the right bias member 31R. The elongate member 54 is prevented from contacting the right terminal 16b by the blocking portion 40b of the blocking member 28, which is in a relaxed state because a foreign object is not also directed towards the middle terminal 18. The shutter assembly 12 thereby provides tamper resistance during unintended uses of the multi-circuit receptacle. In some embodiments, the blocking member 30 comprises a surface 43 that blocks the left terminal 16a in an actuated position.

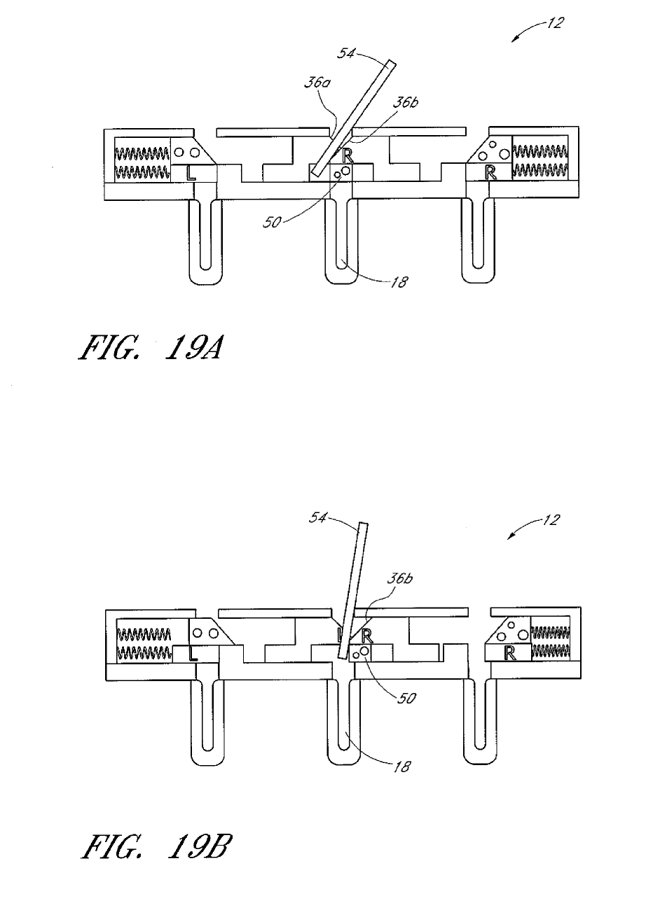

FIGS. 17A and 17B illustrate an example embodiment of an elongate member 54 of a foreign object being directed towards the middle terminal 18. The downward force of the elongate member 54 is distributed due to the angles of the inclined surfaces 36a, 36b of the blocking members 26 and 28 (the ramps of which are denoted as “L” and “R,” respectively), thereby causing the blocking members 26 and 28 to actuate to the left and to the right, respectively, compressing the left and right bias members 27, 29. The elongate member 54 is prevented from contacting the middle terminal 18 by the blocking portion 50 of the blocking member 30 (FIG. 9), which is in a relaxed state because a foreign object is not also directed towards the left terminal 16a or the right terminal 16b. The shutter assembly 12 thereby provides tamper resistance during unintended uses of the multi-circuit receptacle.

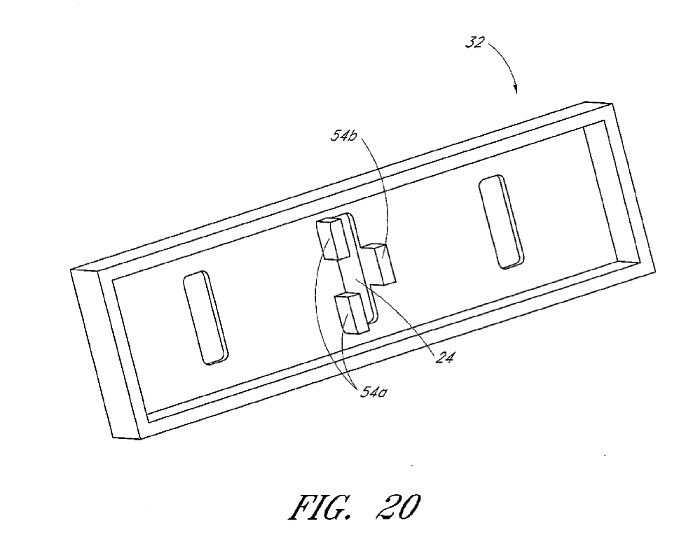

FIGS. 18A and 18B illustrate an example embodiment of a plug 22 comprising a left prong 23L and a right prong 23R being directed towards the middle terminal 18 and the right terminal 16b, respectively. This is an intended use of the multi-circuit receptacle, so the shutter assembly 12 is configured to allow the plug 22 to contact the terminals. As described above with respect to FIGS. 17A and 17B, the downward force of the left prong 23L is distributed due to the angles of the inclined surfaces 36a, 36b of the blocking members 26 and 28 (FIGS. 3 and 4), thereby causing the blocking members 26 and 28 to actuate to the left and to the right, respectively, compressing the left and right bias members 27, 29. As described above with respect to the complement to FIGS. 16A and 16B, the downward force of the right prong 23R is distributed due to the angle of the inclined surface 46b of the blocking member 30 (FIG. 9), thereby causing the blocking member 30 to actuate to the right, compressing the right bias member 31R. The left prong 23L is allowed to contact the middle terminal 18 because the blocking portion 50 of the blocking member 30 has been displaced to the right due to the interaction between the right prong 23R and the inclined surface 46b of the blocking member 30, and the right prong 23R is allowed to contact the right terminal 16b because the blocking portion 40b of the blocking member 28 has been displaced to the right due to the interaction between the left prong 23L and the inclined surface 36b of the blocking member 28. Once the prongs 23L, 23R of the plug 22 have been inserted into the electrical terminals 18 and 16b, power is supplied to the device to which the plug is attached. In some embodiments, the blocking member 30 comprises a surface 43 that blocks the left terminal 16a in an actuated position such that the left terminal 16a is blocked even when the middle terminal 18 and the right terminal 16b are not blocked.

Although not illustrated, it will be appreciated that a plug 22 comprising a left prong 23L and a right prong 23R being directed towards the left terminal 16a and the middle terminal 18 would have a similar effect. This is another intended use of the multi-circuit receptacle, so the shutter assembly 12 is configured to allow the plug 22 to contact the terminals 16a and 18. As described above with respect to FIGS. 16A and 16B, the downward force of the left prong 23L is distributed due to the angle of the inclined surface 46a of the blocking member 30, thereby causing the blocking member 30 to actuate to the left, compressing the left bias member 31L. As described above with respect to FIGS. 17A and 17B, the downward force of the right prong 23R is distributed due to the angles of the inclined surfaces 36a, 36b of the blocking members 26 and 28, thereby causing the blocking members 26 and 28 to actuate to the left and to the right, respectively, compressing the left and right bias members 27, 29. The left prong 23L is allowed to contact the left terminal 16a because the blocking portion 40a of the blocking member 26 has been displaced to the left due to the interaction between the right prong 23R and the inclined surface 36a of the blocking member 26, and the right prong 23R is allowed to contact the middle terminal 18 because the blocking portion 50 of the blocking member 30 has been displaced to the left due to the interaction between the left prong 23L and the inclined surface 46a of the blocking member 30. Once the prongs 23L, 23R of the plug 22 have been inserted into the electrical terminals 16a and 18, power is supplied to the device to which the plug is attached. In some embodiments, the blocking member 30 comprises a surface 41 that blocks the right terminal 16b in an actuated position such that the right terminal 16b is blocked even when the left terminal 16a and the middle terminal 18 are not blocked.

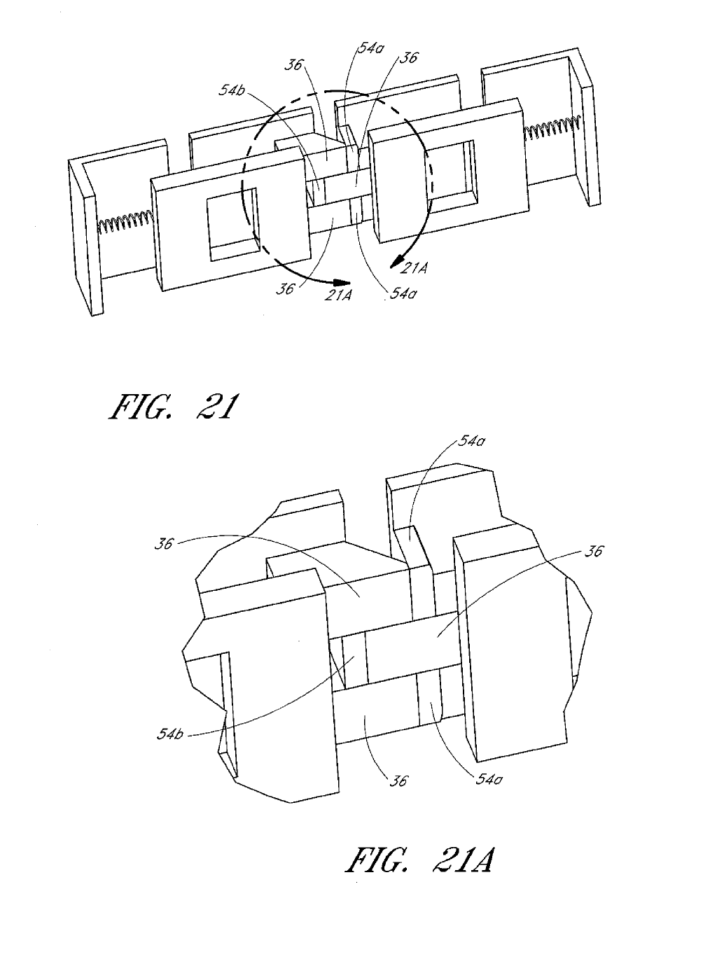

FIGS. 19A and 19B illustrate an example of an elongated member 54 of a foreign object being directed towards the middle terminal 18. In embodiments in which the elongated member 54 is small enough, it may be manipulated (e.g., inserted at a severe angle) to avoid contact with the inclined surfaces 36a, 36b of the blocking members 26 and 28. In certain such embodiments, the elongated member 54 may then be manipulated (e.g., used as a lever) to interact with the open portion 48 and the side of the blocking portion 50 of the blocking member 30 to push both the blocking member 28 and the blocking member 30 to the right, thereby undesirably allowing access to the middle terminal 18.

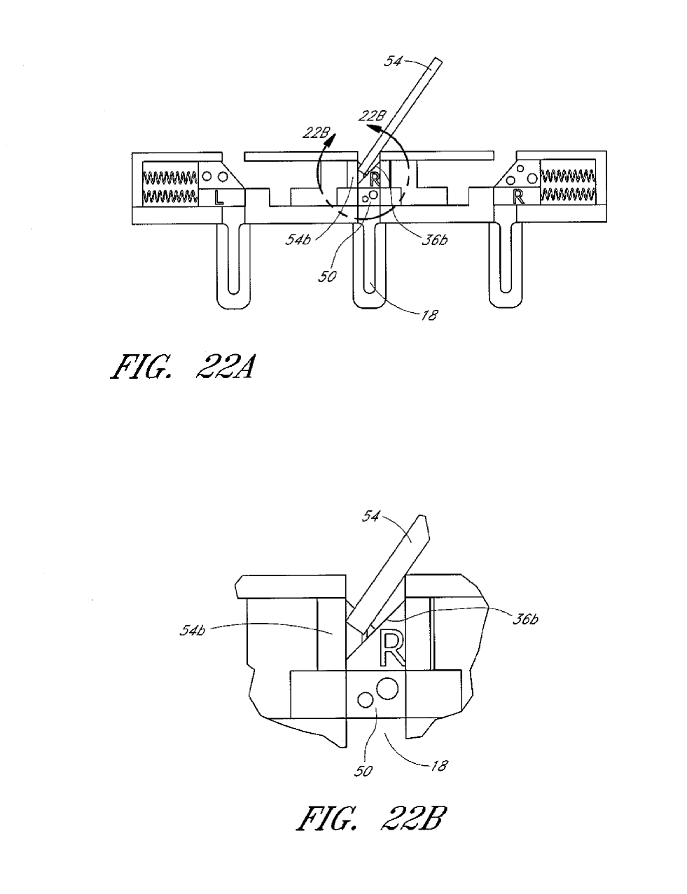

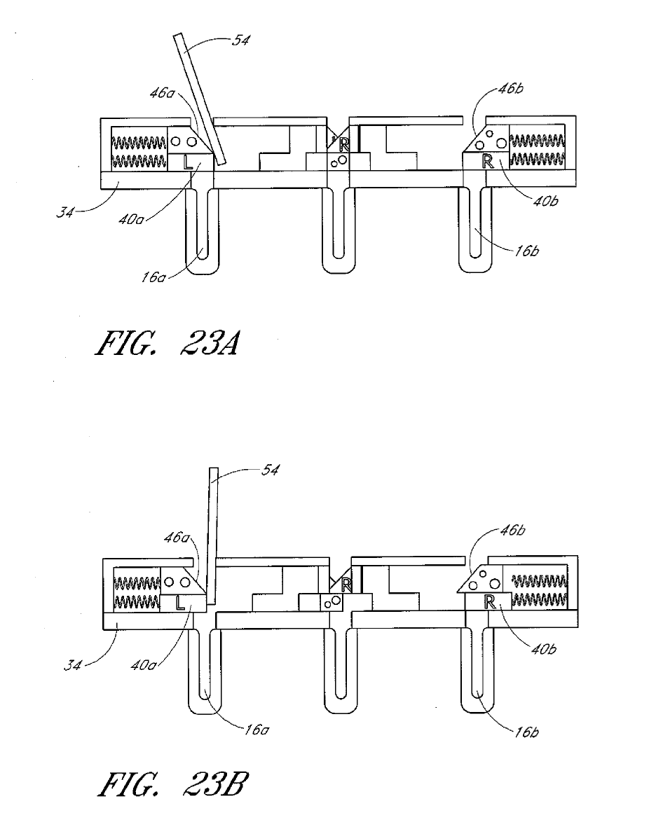

FIG. 20 illustrates a back view of an example embodiment of a face plate 32 that may prevent the event illustrated in FIGS. 19A and 19B. The face place 32 comprises a plurality of space guards 54a, 54b (also referred to as neutral slot open space guards (“NSOSGs”)), located on the inside cavity of TRSA face 32 and proximate (e.g., directly adjacent) to the aperture 24 corresponding to the middle terminal 18. FIGS. 21 and 21A illustrate the space guards 54a, 54b interacting with the fingers 36 of the blocking members 26 and 28. The ends of the fingers 36 abut the space guards 54a, 54b, thereby preventing access to the open portion 48 and the side of the blocking portion 50 of the blocking member 30. FIGS. 22A and 22B illustrate the elongated member 54 being directed towards the middle terminal 18 as depicted in FIGS. 19A and 19B, but in which the space guards 54a, 54b of the face plate 32 prevent the elongated member 54 from being manipulated such that the middle terminal 18 could be accessed. The shutter assembly 12 thereby provides tamper resistance during unintended uses of the multi-circuit receptacle, even with specific manipulation of a specialized foreign object.

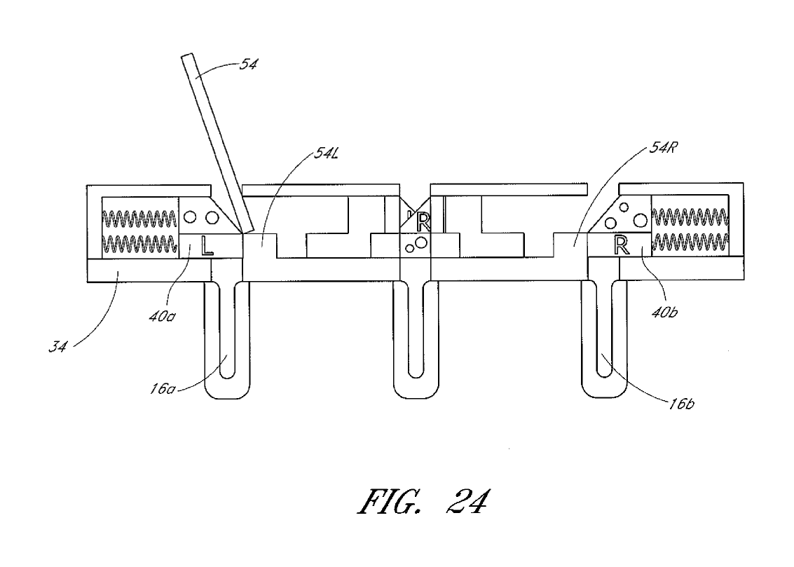

FIGS. 23A and 23B illustrate another example of an elongated member 54 of a foreign object being directed towards the left terminal 16a. In embodiments in which the elongated member 54 is small enough, it may be manipulated (e.g., inserted at a severe angle) to avoid contact with the inclined surface 46a of the blocking member 30. In certain such embodiments, the elongated member 54 may then be manipulated (e.g., used as a lever) to interact with the open portion 38a and the side of the blocking portion 40a of the blocking member 26 to push both the blocking member 30 and the blocking member 26 to the left, thereby undesirably allowing access to the left terminal 16a.

Although not illustrated, it will be appreciated that an elongated member 54 of a foreign object being directed towards the right terminal 16b would have a similar effect. In embodiments in which the elongated member 54 is small enough, it may be manipulated (e.g., inserted at a severe angle) to avoid contact with the inclined surface 46b of the blocking member 30. In certain such embodiments, the elongated member 54 may then be manipulated (e.g., used as a lever) to interact with the open portion 38b and the side of the blocking portion 40b of the blocking member 28 to push both the blocking member 30 and the blocking member 28 to the right, thereby undesirably allowing access to the right terminal 16b.

FIG. 2 illustrates a front view of an example embodiment of a back plate 34 that may prevent the event illustrated in FIGS. 23A and 23B. The back plate 34 comprises a plurality of space guards 54L, 54R (or hot slot open space guards (“HSOSGs”)) proximate (e.g., directly adjacent) to the apertures 25 corresponding to the left and right terminals 16a, 16b, respectively. FIG. 24 illustrates the elongated member 54 being directed towards the left terminal 16a as depicted in FIGS. 23A and 23B, but in which the left space guard 54L of the back plate 34 prevents the elongated member 54 from being manipulated such that the left terminal 16a could be accessed. Although not illustrated, it will be appreciated that the right space guard 54R of the back plate 34 prevents the elongated member 54 from being manipulated such that the right terminal 16b could be accessed. The shutter assembly 12 thereby provides tamper resistance during unintended uses of the multi-circuit receptacle, even with specific manipulation of a specialized foreign object.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above.

1. A shutter assembly for an electrical receptacle, comprising a plurality of apertures each configured to be in communication with a different one of at least three terminals of the electrical receptacle, the shutter assembly configured to block access to each of the terminals upon insertion of a foreign object into only one of said apertures, the shutter assembly configured to allow access to two of the terminals upon simultaneous insertion of two prongs of a plug into two of said apertures.

2. The shutter assembly of claim 1, further comprising a ground terminal.

3. The shutter assembly of claim 1, wherein two of the terminals are hot terminals and one of the terminals is a neutral terminal.

4. (canceled)

5. An electrical receptacle comprising:
at least three terminals; and
a shutter assembly comprising a plurality of apertures configured to be in communication with a different one of the at least three terminals, the shutter assembly configured to block access to each of the three terminals upon insertion of a foreign object into only one of said apertures, the shutter assembly configured to allow access to two of the terminals upon simultaneous insertion of two prongs of a plug into two of said apertures.

6. The receptacle of claim 5, further comprising a ground terminal.

7. The receptacle of claim 5, wherein two of the terminals are hot terminals and one of the terminals is a neutral terminal.

8. (canceled)

9. A shutter assembly for an electrical circuit comprising at least three terminals configured to receive a plug having two prongs, the shutter assembly comprising:
a first blocking member comprising a first inclined surface, a first open portion, and a first blocking portion configured to cover at least a first terminal of said terminals in a relaxed position;
a first bias member configured to bias the first blocking member towards its relaxed position when the first blocking member is moved to an actuated position of the first blocking member;
a second blocking member comprising a second inclined surface, a second open portion, and a second blocking portion configured to cover at least a second terminal of said terminals in a relaxed position;
a second bias member configured to bias the second blocking member toward its relaxed position when the second blocking member is moved to an actuated position of the second blocking member;
a third blocking member comprising a third inclined surface, a third open portion, and a third blocking portion configured to cover at least a third terminal of said terminals in a relaxed position; and
a third bias member configured to bias the third blocking member towards its relaxed position when the third blocking member is moved to an actuated position of the third blocking member.

10. The shutter assembly of claim 9, wherein the first blocking member comprises at least one finger comprising the first inclined surface, and the second blocking member comprises at least one finger comprising the second inclined surface, a ramp defining the first inclined surface substantially aligned with a ramp defining the second inclined surface, and the first inclined surface facing an opposite direction than the second inclined surface.

11. The shutter assembly of claim 10, wherein the finger of the first blocking member is adjacent to the finger of the second blocking member when the first and second blocking members are in their relaxed positions.

12. The shutter assembly of claim 10, wherein the second blocking member comprises at least two fingers comprising the second inclined surface, the finger of the first blocking member disposed between the fingers of the second blocking member when the first and second blocking members are in their relaxed positions.

13. The shutter assembly of claim 10, wherein the first blocking portion and the second blocking portion are disposed substantially on a first plane, and wherein the finger of the first blocking member and the finger of the second blocking member are disposed substantially on a second plane.

14. The shutter assembly of claim 13, wherein the third blocking portion is disposed substantially on the first plane and wherein a ramp defining the third inclined surface is disposed substantially on the second plane.

15. The shutter assembly of claim 9, wherein the first open portion comprises an aperture.

16. The shutter assembly of claim 15, wherein the aperture of the first blocking member comprises a slot.

17. The shutter assembly of claim 15, wherein the second open portion member comprises an aperture.

18. The shutter assembly of claim 17, wherein the apertures of the first and second blocking members comprise slots.

19. The shutter assembly of claim 17, wherein the third open portion comprises an aperture.

20. The shutter assembly of claim 19, wherein the third blocking portion is disposed within the aperture of the third blocking member to define a plurality of apertures.

21. The shutter assembly of claim 9, wherein the third blocking member comprises a plurality of inclined surfaces facing in opposite directions.

22. (canceled)

23. The shutter assembly of claim 21, wherein inclined surfaces of the third blocking member face away from each other.

24-41. (canceled)
